(19) United States
(12) Patent Application Publication
(10) Pub. No.: US 2018/0264896 A1
(43) Pub. Date: Sep. 20, 2018

(54) TIRE FOR ATTENUATING ROLLING NOISE

(71) Applicant: COMPAGNIE GENERALE DES ETABLISSEMENTS MICHELIN, Clermont-Ferrand (FR)

(72) Inventors: Nicolas DAUTREY, Tokyo (JP); Yasufurni NAKASHIMA, Tokyo (JP)

(73) Assignees: COMPAGNIE GENERALE DES ETABLISSEMENTS MICHELIN, Clermont-Ferrand (FR); MICHELIN RECHERCHE ET TECHNIQUE, S.A., Granges-Paccot (CH)

(21) Appl. No.: 15/539,451

(22) PCT Filed: Dec. 17, 2015
(86) PCT No.: PCT/JP2015/086152

§ 371 Date: Jun. 23, 2017

(30) Foreign Application Priority Data
Dec. 26, 2014 (JP) PCT/JP2014/084759

(51) Int. Cl. B60C 19/00; B60C 9/18; B60C 11/03; B60C 11/04; B60C 11/13

(52) U.S. Cl. CPC B60C 19/002; B60C 9/1807; B60C 11/032; B60C 11/04; B60C 11/1353; B60C 11/0306

(57) ABSTRACT

Present disclosure provides a tire including a summit surrounded on both sides by sidewalls, including a carcass reinforcement extending in the summit and the sidewalls, and anchored at its two ends in the beads, the carcass reinforcement being surmounted radially on the outside by a summit reinforcement composed of a plurality of reinforcing plies, said summit reinforcement being surmounted radially on the outside by a tread intended to come into contact with a ground during use of the tire, the tire comprising in its summit, at least one cavity acting as a resonator and in fluid communication with the outside of the tire, when the tire is mounted onto a mounting rim each cavity having an appropriate volume to form a calibrated resonator to attenuate the noise in a frequency range between 500 and 2000 Hz.

### FIELD OF INVENTION

The present invention relates to a tire for attenuating rolling noise generated by the tire.

### BACKGROUND

In many countries, regulations have been established to impose a significant reduction of the noise generated by vehicles during travel. This led tire manufacturers to seek to attenuate the noise from the tires during tire rolling.

A tire for a passenger vehicle comprises a summit between each sidewalls terminating in beads. The tire further comprises a carcass reinforcement extending in the summit and the sidewalls, and anchored at both ends in the beads. The carcass reinforcement is surmounted by a summit reinforcement usually including a plurality of reinforcing plies. The summit reinforcement is surmounted by a tread intended to come into contact with a ground.

It is known that the noise from the tires includes various components, that is the component from external noise and the component from the internal noise. The external (rolling) noise includes a resonance noise of the air flowing in the grooves of the tread during passage in contact, a noise generated by the vibration of the air in the space formed between the tire and the ground and a noise generated in the external part of the tire on the side of the sidewalls. Among the components from the internal noise, there is a noise, called “cavity noise”, that is linked to a resonance of the air contained in the internal cavity of the tire and subjected to an inflation pressure.

Various solutions have been proposed to attenuate these external noises.

It is known to form a cavity in fluid communication with the outside space and having a suitable dimension to act as a resonator (like Helmholtz or quarter-wave type resonator) in the tire structure for attenuating rolling noise.

European Patent No 2 240 335 B1 discloses a cavity formed in a tread of the tire which cavity being provided to open to a groove and function as a Helmholtz resonator. The cavity is distributed uniformly in a circumferential direction so that at least one cavity is always included within a range of footprint of the tire contacting with the ground.

This cavity can satisfactory attenuate the rolling noise. On the other hand, such cavity decreases the stiffness of the tire and the stiffness becomes locally different in the tire, and therefore high performance cannot be achieved.

Moreover, in order to make an efficient resonator, it is necessary to increase the volume of resonators. However, such increased resonator further decreases the stiffness of the tire and performance thereof.

Definitions:

A block is an element in relief formed on the tread which is delimited by recesses or grooves and comprising the side faces and a contact face intended to come into contact with the ground. This contact face has a geometric center defined as the center of gravity or centroid of the face.

A ridge is a raised element formed on a tread, this element extending in the circumferential direction and circling the tire. A rib comprises two side walls and a contact face, the latter being intended to come into contact with the ground during rolling.

Radial direction by means herein a direction which is perpendicular to the axis of rotation of the tire (this direction is the direction of the thickness of the tread).

For transverse or axial direction means a direction parallel to the axis of rotation of the tire.

By circumferential direction means a direction which is tangent to any circle centered on the axis of rotation. This direction is perpendicular to both the axial direction and a radial direction.

Axially outwardly by means a direction which is oriented towards the outside of the internal cavity of the tire.

Equatorial plane: plane perpendicular to the axis of rotation and passing through the points of the tire are axially outermost, equatorial plane virtually dividing the tread of the tire into two halves of substantially equal widths.

The total thickness E of a tread measured on the equatorial plane of the tire provided with this tread, between the tread surface and the radially outermost of the summit reinforcement at new state.

The tread has a maximum thickness PMU of material to use when rolling, this maximum thickness PMU being less than the total thickness E.

The usual driving conditions or tire conditions are those defined by the ETRTO standard; these terms and conditions specify the inflation pressure corresponding reference to the load capacity of the tire indicated by the load index and speed code. These Terms of Use may also be called “nominal conditions” or “terms of use”.

A cutout is generically designates a groove or an incision and is limited by the material of the walls facing each other and spaced apart from each other by a non-zero distance (called “width of the cutout”). What differentiates an incision of a groove it is precisely this distance; in the case of an incision, this distance is suitable to allow the contacting of at least partially opposite said incision defining at least during passage through the ground contact walls. In the case of a groove, the walls of the groove may come into contact against each other under normal rolling conditions.

### SUMMARY OF THE INVENTION

An object of the present invention is to provide a solution to attenuate external rolling noise of a tire, especially noise in frequencies 500 Hz to 2000 Hz, while maintaining an appropriate level of stiffness of the tire and keeping the other performance of the tire during rolling.

To this end, the invention provide a tire intended to be mounted on a mounting rim, this tire comprising a summit surrounded on both sides by sidewalls terminating in beads provided to cooperate with the mounting rim of the tire, the tire comprising a carcass reinforcement anchored at its two ends in the beads, the carcass reinforcement extending in the sidewalls and in the summit of the tire and being surmounted radially on the outside by a summit reinforcement composed of a plurality of reinforcing plies, said summit reinforcement being surmounted radially on the outside by a tread intended to come into contact with a ground during use of the tire, the tire comprising in its summit, at least one cavity and in fluid communication with the outside of the tire when the latter is mounted on its rim, each cavity having an appropriate volume to form a calibrated resonator to attenuate at least partly the noise in a frequency range between 500 and 2000 Hz, the tire being characterized in that each cavity forming a resonator is arranged substantially uniformly in the circumferential direction and is filled with a fibrous or a filamentary material.

According the tire thus constructed, the noise or an amplitude in the predetermined frequency range can be attenuated/eliminated.

The fibrous or the filamentary material used is a fabric material of which interest is to be both lightweight and rigid enough to allow proper operation once incorporated into the structure from the summit of the tire.

The fibrous or the filamentary material used as the fabric material is exampled such as aramid, glass, cellulose, nylon, vinylon, polyester, polyolefin, rayon, polyethylene, ethylene-vinyl acetate, ethylene-vinyl alcohol, polyvinyl alcohol and mixture thereof; which provides satisfactory high level of plastic deformation to sustain tire rolling cycles when received in the cavity (resonator) in the summit of the tire. The fibrous or the filamentary material may have multi components structure.

In another advantageous embodiment, the tread includes at least one groove, and each cavity is formed radially inward of the groove and each cavity is adapted to open to the groove.

According to this arrangement, flexing of the tire in the circumferential direction can be facilitated.

In another advantageous embodiment, a plurality of cavities is formed and each cavity is separately placed in the circumferential direction and opens to the groove.

In another advantageous embodiment, a plurality of cavities is formed and cavity is separately placed in the transverse direction and opens to the groove.

In another advantageous embodiment, a plurality of cavities is formed and each of cavities is separately placed in circumferential and transverse directions and the cavities are distributed uniformly in transverse direction.

This arrangement has the advantage of facilitating flexing of the tire in the transverse direction.

In another advantageous embodiment, the cavity is formed so as not to come in contact with the ground after wear of the tread until a legal wear limit is reached.

The advantage of such an arrangements is to prevent the cavity filling material from coming into contact with the ground and can degrade the performance in contact.

In another advantageous embodiment, the fibrous or the filamentary material filling the cavities is a fabric material.

In another advantageous embodiment, fabric material is selected from the group consisting of woven fabric, unwoven fabric and mixture of these fabrics.

These materials have the advantage of providing suitable mechanical properties for this application as a filler material of the cavity such as resonator in the tire summit, that is to say satisfactory high young's modulus in a tire radial direction, for example more than 0.5 MPa, preferably more than 0.7 MPa and more preferably more than 1.0 MPa and still more preferably more than 1.5 MPa, and allows an elongation in its extension direction while maintaining air circulation in it. This fabric material may be a composite or a laminate of fabrics made of different fibrous or filamentary materials.

In another advantageous embodiment, an apparent density of the fabric material is at least equal to 0.05 and at most equal to 0.5 g/cm³ according to JIS Z 8807.

This apparent density is according to JIS Z 8807: 2012 and in particular “Method of measuring the density and specific gravity by geometrical measurement” described in chapter 9 of such standard. This density range is the range to satisfy both sufficient stiffness of the tread and air circulation inside the fibrous or the filamentary material installed onto the summit of the tire.

In another advantageous embodiment, an air permeability of the fabric material is at least equal to 10 g/cm³/cm²/s according to JIS L 1096.

It was observed that an air permeability of the fabric material should preferably be at least equal to 10 g/cm³/cm²/s, and even more preferably at least equal to 12 g/cm³/cm²/s and still more preferably at least equal to 14 g/cm³/cm²/s. This air permeability is according to JIS L 1096. If the air permeability is less than 10 g/cm³/cm²/s, it is not certain that the resonator can still play its role as resonator or a void which let the air flow may become insufficient.

Preferably, each cavity forms a Helmholtz resonator, this type of resonator is relatively simple and easy to be calibrated according to the sound frequencies that are desired to attenuated, but of course each cavity resonator can be a quarter-wave type.

### BRIEF DESCRIPTION OF THE DRAWINGS

Other characteristics and advantages of the invention appear from the description given hereinafter with reference to the accompanying drawings which show, by way of non-limiting examples, embodiments of the present invention.

FIG. 1 is an exploded view of a summit portion of a tire according to a first embodiment of the present invention;

FIG. 2 shows a meridian section of the summit of the tire shown in FIG. 1;

FIG. 3 is an exploded view of a tire according to a second embodiment of the present invention;

FIG. 4 shows a meridian section of the summit of the tire shown in FIG. 3;

FIG. 5 is a plan view of a summit surface of the tire according to a third embodiment of the present invention;

FIG. 6 is a partially cut-way perspective view showing a section of a summit of the tire according to a fourth embodiment of the present invention.

### DETAILED DESCRIPTION OF THE INVENTION

To facilitate the understanding of the arrangement of the embodiment, the same reference numerals are used to refer to elements of the same nature in the description.

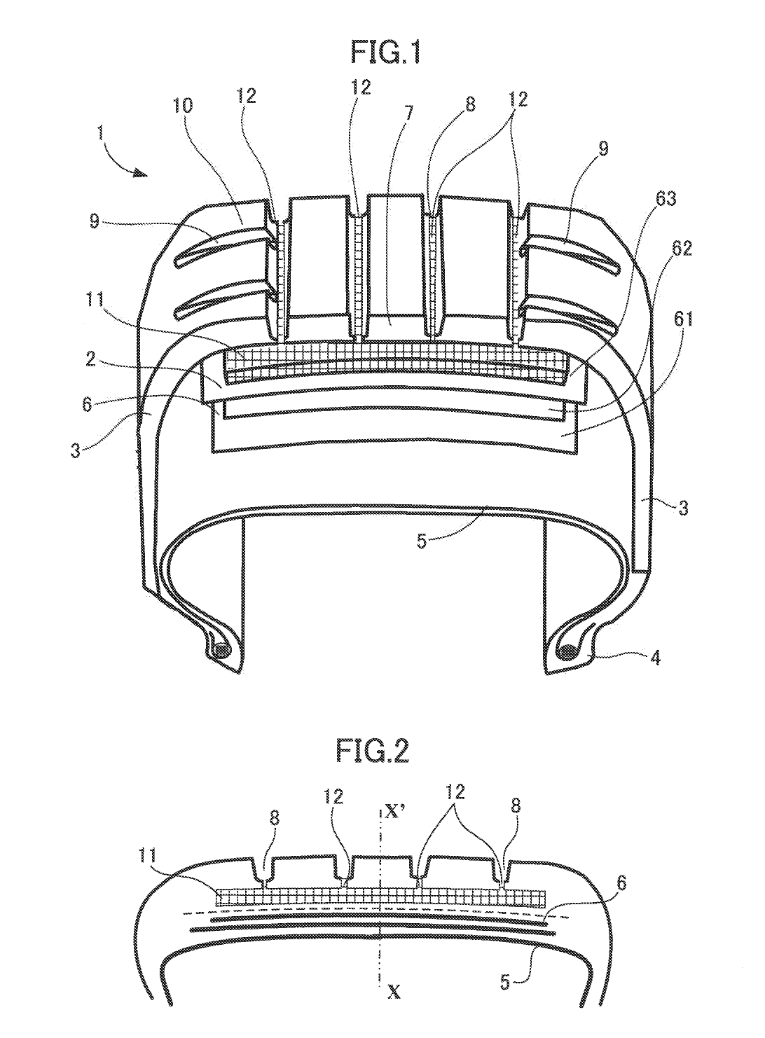

FIG. 1 is an exploded view of a tire according to a first embodiment of the present invention. FIG. 2 shows a meridian section (that is to say in a plane containing the axis of rotation of the tire) of a summit of the tire shown in FIG. 1.

In the first embodiment, the tire 1 having size 205/55R16 comprises a summit 2 connected at its axial ends to sidewalls 3 terminating in beads 4. The tire 1 also comprises a carcass reinforcement 5 extending in the summit 2 and the sidewalls 3, and anchored at both ends in the beads 4.

The carcass reinforcement 5 is surmounted radially on the outside by a summit reinforcement 6 including belt plies 61, 62, 63. Two belt plies 61, 62 are crossed from the other ply or a cap ply 63. The summit reinforcement 6 is surmounted by a tread 7 intended to come into contact with the ground during use of the tire.

The tread 7 includes four main grooves 8 extending generally in circumferential direction and a plurality of transverse grooves 9. These circumferential and transverse grooves defining a plurality of blocks 10 in the tread 7.

in the present embodiment, each main groove 8 has a width of 6 mm and a depth of 6 mm. This dimension is suitable to reserve a thickness of rubber material between a groove bottom and the summit reinforcement 6. As shown in FIGS. 1 and 2, radially inward of the main grooves 8, a cavity 11 having a rectangular cross section is provided. The cavity 11 is sized or made so as to function as a resonator to attenuate at least partially the noise in a frequency range between 500 and 2000 Hz, such as Helmholtz or quarter-wave type resonator.

The cavity 11 has a uniform rectangular cross section in circumferential direction and specifically has a width in the transverse direction (direction of the axis of tire rotation) of 140 mm and a height (thickness) in radial direction of 3 mm. The cavity 11 continuously extends in a circumferential direction so as to form cylindrical space in the summit 2.

This cavity 11 is transversely centered on the equatorial plane of the tire (indicated by the line XX′ in FIG. 2) and has a transverse width substantially equal to the width of the second belt ply 62 of the summit reinforcement. The distance between a bottom surface of the groove 8 and a radially outer surface of the cavity 11, is preferably 0.5 mm or more.

In the bottom of the main groove 8, an exhaust groove 12 is provided. The exhaust groove (neck) 12 continuously extends in the circumferential direction along the entire length of the main groove 8. One radial end of the exhaust groove 12 is connected to the cavity 11 and the other radial end of the exhaust groove 12 is open to the bottom of the main groove 8 so that the cavity 11 opens to the main groove 8 through the exhaust groove 12. The other radial end of the exhaust groove 12 may open to other part of the main groove 8.

Each exhaust groove 12 has a width of 6 mm measured in the transverse direction and a height of 0.5 mm.

The exhaust groove 12 may be discontinuous in circumferential direction in order to maintain sufficient tread stiffness, especially in transverse bending (that is to say heading about an axis tangent to the circumferential direction).

The cavity 11 is filled with an unwoven fabric, for example an unwoven fabric sold under the trade name “Flextar”(trademark) by “Kuraray Co., Ltd,”. Density of the unwoven fabric is 0.10 g/cm³ according to ITIS Z 8807, and an air permeability of the unwoven fabric is 26.2 g/cm³/cm²is according to JIS L 1096.

The unwoven fabric is introduced into the tire during molding and vulcanization step in manufacturing process of the tire. The unwoven fabric filling the cavity combined with the main grooves 8 forms a resonator capable of reducing noise generated between the tread and the ground.

With such an arrangement, there is a attenuation of the acoustic emission of the order of 2.2 dB at 70 kph according to ECE R117 (Directive 2005/11/EC) compared to the same tire devoid of any anti rolling noise resonator.

In the first embodiment, the material filling the cavity 11 is sufficiently distant from the rolling surface (contact face) of the tread 7 so as not to interfere with the conditions of contact of the tire on a ground even after partial wear.

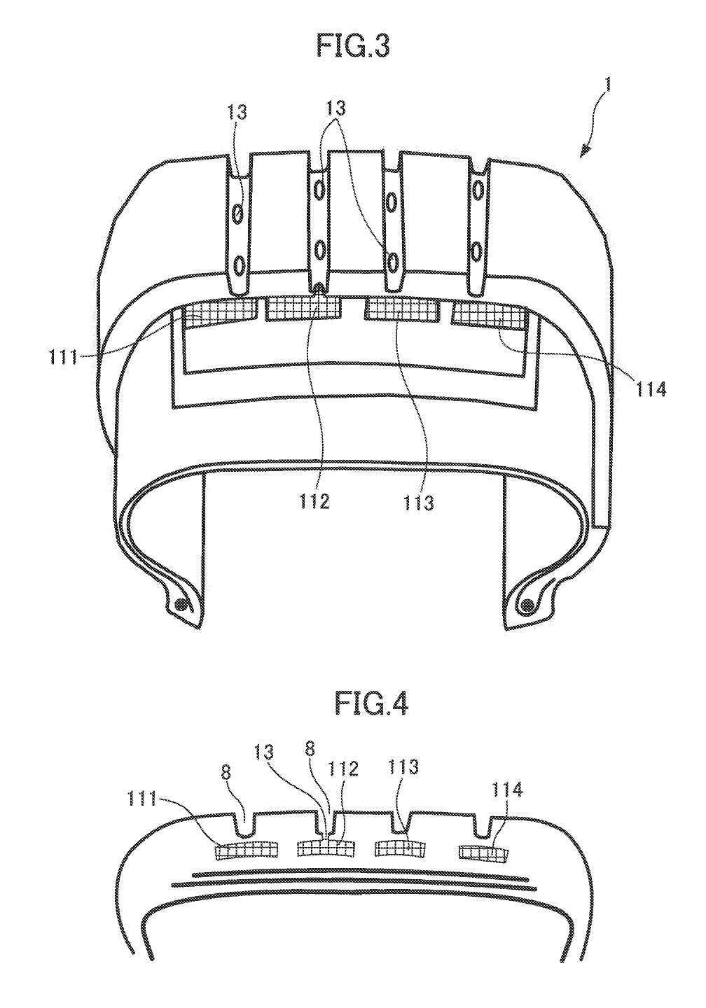

FIG. 3 is an exploded view showing a tire according to a second embodiment of the present invention. FIG. 4 shows a meridian section of the summit portion of the tire shown in FIG. 3.

A tire according to the second embodiment has the substantially the same structure as that shown in FIG. 1 except that a cap ply is not provided and that four cavities 111, 112, 113, 114 acting as Helmholtz resonator are provided separately from each other in a transverse direction.

In the second embodiment, each cavity 111, 112, 113, 114 is formed to be located radially inwardly of the main grooves 8, respectively. Each cavity is filled with a fibrous or a filamentary material and has an appropriate volume so as to act as a Helmholtz resonator.

In the bottom of the main groove 28, a plurality of wells (through necks) 13 is provided. A radially inward end of the well 13 is connected to the cavity 111, 112, 113, 114 and a radially outward end of the well 13 is open to the main groove 8 so that the cavity 111, 112, 113, 114 opens to the main groove 8 through the well 13.

Each cavity 111, 112, 113, 114 has a uniform rectangular cross section in circumferential direction and continuously extends in the circumferential direction so as to form cylindrical space in the summit 2.

Alternatively, the main groove may be obliquely oriented with respect to a circumferential direction by an average angle from zero and less than 90°. In this case, the cavities are oriented in the same manner as the main groove. Preferably, the average angle of the groove is with respect to the circumferential direction between 15° and 50°. In this case, each main groove may extend from one edge to the other of the tread of the tire or from around axially the center of the tread to one edge of the tread of the tire, and each cavity may extend also from one edge to the other of the summit of the tire or from around axially the center of the summit to one edge of the summit of the tire. The cavities may be oriented in different direction toward the direction which the grooves are oriented.

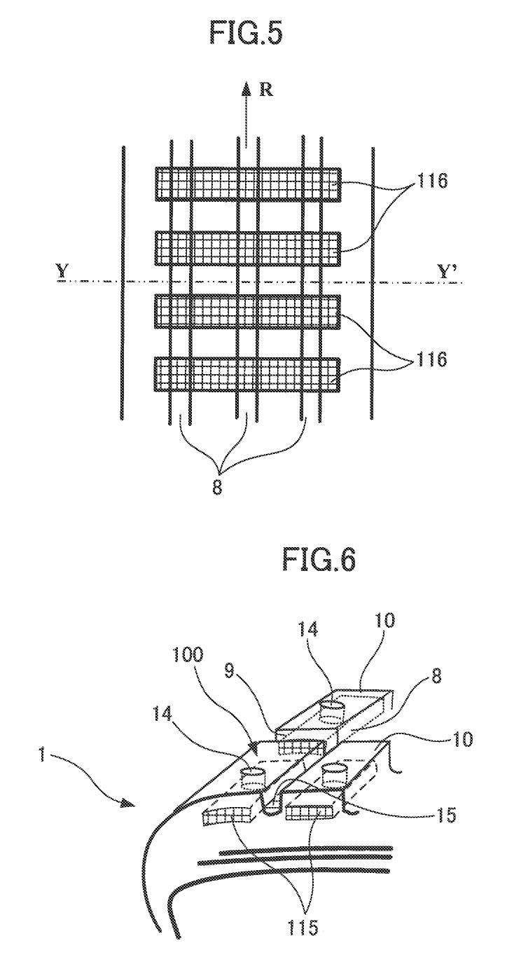

FIG. 5 is a plan view of a summit surface of the tire according to a third embodiment of the present invention.

In this embodiment, a plurality of cavities 116 is circumferentially arranged in a radially inward position of the main grooves 8. As shown in FIG. 5, each of cavities 116 has an elongated shape and extends in a transverse direction so as to perpendicularly traverse the main grooves 8. That is, the plurality of cavities 116 is uniformly arranged in a circumferential direction.

The cavity 116 is filled with a fibrous or a filamentary material. Each cavity 116 is in connection to three main grooves 8 through a neck which circumferentially opens. The cavities 16 are not connected to each other in the circumferential direction and extend in the whole transverse width of the summit reinforcement (in the direction YY′ parallel to the tire rotation direction).

Advantageously, this arrangement does not change bending flexibility too much in the flattening of the tread in the region of contact with the ground. Alternatively, the cavities can be oriented obliquely to a non-zero angle with the direction YY′.

FIG. 6 is a partially cut-way perspective view showing a tire summit according to a fourth embodiment of the present invention. In this embodiment, a tread comprises a plurality of blocks 10 separated from each other or delimited by circumferential main grooves 8 and transverse grooves 9. A cavity 115 is independently formed in each block 10. In a contact face 100 of each block 10, is provided a through neck 14 radially oriented and connecting the cavity 115 and the outside space of the tire. The cavities are uniformly arranged in a circumferential direction. The cavity 115 is filled with a fibrous or a filamentary material and acts as a resonator.

According to this arrangement, the cavity 115 can be directly connected to a space formed between the ground and the contact face via the through neck 14.

Advantageously, the cavity 115 is formed at a radially inner position with respect to the legal wear limit of the tread so that the filling material does not interfere with the ground during rolling. In the fourth embodiment, a wear limit indicator 15 showing legal wear limit is provided at the bottom of the main groove 8. Since the filling material in each cavity is positioned at a radially inner position than the wear limit indicator 15, the filling material does not come into contact with the ground during the legally permitted use.

1. Tire mounted on a mounting rim, comprising:
a summit surrounded on both sides by sidewalls terminating in beads to cooperate with the mounting rim of the tire;
a carcass reinforcement extending in the summit and the sidewalls, and
anchored at its two ends in the beads, the carcass reinforcement being surmounted radially on the outside by a summit reinforcement composed of a plurality of reinforcing plies, said summit reinforcement being surmounted radially on the outside by a tread that contacts with a ground during use of the tire,
wherein the summit includes at least one cavity acting as a resonator and in fluid communication with an outside of the tire,
when the tire is mounted onto the mounting rim each cavity has an volume configured to form a calibrated resonator to attenuate the noise in a frequency range between 500 and 2000 Hz,
each cavity being arranged substantially uniform in the circumferential direction and is filled with a fibrous or a filamentary material.

2. Tire according to claim 1, wherein said tread includes at least one groove, and each cavity being formed radially inward of the groove and each cavity is adapted to open to the groove.

3. Tire according to claim 2, further comprising a plurality of cavities, and each cavity is separately placed in the circumferential direction and each cavity opens to the groove.

4. Tire according to claim 2, further comprising a plurality of cavities, and each cavity is separately placed in the transverse direction and each cavity opens to the groove.

5. Tire according to claim 1, wherein further comprising a plurality of cavities, and each cavity is separately placed in circumferential and transverse directions and the cavities being distributed uniformly in transverse direction.

6. Tire according to claim 1, further comprising the cavity is formed so as not to come in contact with the ground after wear of the tread until a predefined amount is not reached.

7. Tire according to claim 1, wherein the fibrous or the filamentary material filling the cavities is a fabric material.

8. Tire according to claim 7, wherein the fabric material is selected from the group consisting of woven fabric, unwoven fabric and mixture of these fabrics.

9. Tire according to claim 7, wherein an apparent density of the fabric material is at least equal to 0.05 and at most equal to 0.5 g/cm³ according to JIS Z 8807.

10. Tire according to claim 7, wherein an air permeability of the fabric material is at least equal to 10 g/cm³/cm²/s according to JIS L 1096.
